(19) United States
(12) Patent Application Publication
(10) Pub. No.: US 2003/0178552 A1
(43) Pub. Date: Sep. 25, 2003

(54) High dynamic range optical signal receiver

(76) Inventors: Rudolf J. Hofmeister, Sunnyvale, CA (US); Frank H. Levinson, Palo Alto, CA (US); Jan Lipson, Cupertino, CA (US)

Correspondence Address: Pennie & Edmonds, LLP, 3300 Hillview Avenue, Palo Alto, CA, 94304, US

(21) Appl. No.: 10/364,571

(22) Filed: Feb. 10, 2003

Related U.S. Application Data
(60) Provisional application No. 60/355,024, filed on Feb. 8, 2002.

(51) Int. Cl. H01J 40/14

(52) U.S. Cl. 250/214 R; 250/214 A

(57) ABSTRACT

An optical signal receiver has an increased dynamic range for detecting optical signals whose intensity varies over a wide range. In one embodiment, the optical signal receiver includes a circuit operable to provide a reverse bias voltage and an avalanche photo-diode (APD) coupled to the circuit to receive the reverse bias voltage. The circuit is operable to lower the reverse bias voltage in response to an increase in power of the received optical signals. Since the current gain of the APD is a function of the reverse bias voltage, the circuit indirectly lowers the current gain of the APD in response to the increase in power of the received optical signals. As a result, the optical signal receiver can be used to detect optical signals whose intensity varies over a broad range.

The present application claims priority to U.S. Provisional Patent Application serial No. 60/355,024, filed Feb. 8, 2002, which is incorporated herein by reference.

### BRIEF DESCRIPTION OF THE INVENTION

The present invention relates generally to optical signal receivers, and more particularly, to an improved optical signal receiver or transceiver for detecting optical signals whose intensity varies over a wide range.

### BACKGROUND OF THE INVENTION

Optical signal receivers, in general, function to convert optical signals into electrical signals. A typical optical signal receiver includes a photo-detector connected to the input of an amplifier (e.g., a transimpedance amplifier). The photo-detector converts the optical signal it has received into an electric current that is supplied to the amplifier. The amplifier then generates at its output a voltage or current that is proportional to the electric current. The photo-detector is typically either an avalanche photo-diode (APD) or a PIN (p-intrinsic-n) photo-diode.

APDs are significantly better than PINs for detecting low-intensity optical signals. The avalanche effect in APDs magnifies the photo-current for a given intensity of input light, and the sensitivity of an APD receiver increases by an amount roughly equal to the current gain. Unfortunately, the maximum permissible input optical power to the APD receiver also drops by the same amount. This is because the photo-current generated by the APD may overload the pre-amplifier or other receiver circuits of the receiver. Thus, most conventional APD receivers have a lower maximum input optical power (or, overload power) than most conventional PIN receivers. Because of this low overload power, conventional APD's are not used in short haul optical links where the signal intensity is typically high.

Accordingly, what is needed is an APD optical signal receiver that has a broader dynamic range than conventional APD receivers such that it can be used in both long haul and short haul optical links.

### SUMMARY OF THE INVENTION

An embodiment of the present invention is an optical signal receiver that has a high dynamic range to accommodate both low intensity and high intensity optical signals. In this embodiment, the high dynamic range is achieved by reducing the reverse bias voltage of the photo-diode of the optical signal receiver in response to strong optical signals. The reduced reverse bias voltage lowers the current gain and reduces the sensitivity of the photo-diode. When the incoming optical signals are weak, the reverse bias voltage of the photo-diode and its sensitivity is not significantly affected.

In some embodiments, the reverse bias voltage of the photo-diode is provided by a resistor that is placed in series between a voltage source and the photo-diode. When the intensity of the incoming optical signals is low, a small photo-current will be generated. Since the same photo-current flows across the resistor, the voltage drop across the resistor will be small, and the reverse bias voltage is not significantly affected. As the intensity of the optical signals increases, the photo-current through the photo-diode increases. The increase in the photo-current results in a corresponding increase in the voltage drop across the resistor and a corresponding reduction in the reverse bias voltage. The reduction in the reverse bias voltage, in turn, reduces the current gain in the photo-diode.

In other embodiments, a current sensor is coupled to the photo-diode to detect the photo-current. The current sensor is coupled to a voltage converter that provides the reverse bias voltage to the photo-diode. The voltage converter decreases the reverse bias voltage in response to increases in photo-current. The reduction in the reverse bias voltage in turn reduces the current gain in the photo-diode.

### BRIEF DESCRIPTION OF THE DRAWINGS

For a better understanding of the invention, reference should be made to the following detailed description taken in conjunction with the accompanying drawings, in which:

FIG. 1 depicts a portion of an optical signal receiver in accordance with a first embodiment of the present invention;

FIG. 2 depicts a portion of an optical signal receiver in accordance with a second embodiment of the present invention; and

FIGS. 3A and 3B depict a current sensor for use in a third embodiment of the present invention;

FIG. 4 depicts a portion of an optical signal receiver in accordance with yet another embodiment of the present invention.

### DESCRIPTION OF PREFERRED EMBODIMENTS

Preferred embodiments of the invention are described below. In the interest of clarity, not all features of an actual implementation are described. It will be appreciated that in the development of any such embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The current gain of an avalanche photo-diode (APD) increases non-linearly with its reverse bias voltage. The present invention takes advantage of this characteristic of the APD by varying its reverse bias voltage according to the intensity of received optical signals. More specifically, an embodiment of the present invention reduces the reverse bias voltage in response to a high intensity optical signal by decreasing the current gain of the APD. Reducing the current gain of the APD results in reduced sensitivity. In one embodiment, the current gain of the APD drops to near unity (at which point the APD operates like a photo-diode) when the photo-current approaches the maximum input current limit of a pre-amplifier circuit of the optical signal receiver. Thus, in that embodiment, the APD optical signal receiver has a similar overload power as a PIN optical signal receiver that shares similar amplifier and pre-amplifier circuitry.

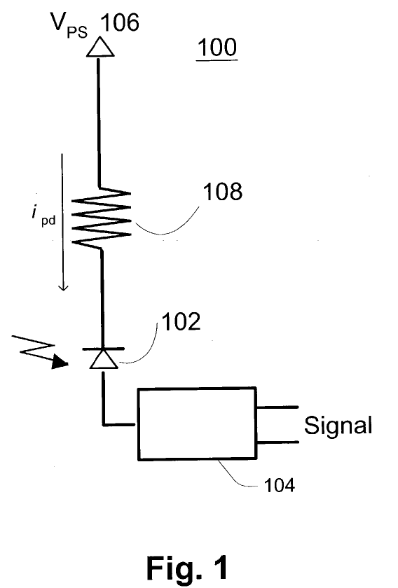

FIG. 1 is a block diagram depicting a portion of an optical signal receiver 100 in accordance with a first embodiment of the invention. The optical signal receiver 100 includes an APD 102 that is coupled to an amplifier 104. When a reverse bias voltage is applied to the APD 102, the APD 102 will generate a photo-current in response to an input optical signal. The photo-current generated by APD 102 is amplified by the amplifier 104 to generate an output signal (e.g., an output voltage or an output current). Also illustrated is a voltage source 106. In operation, the voltage source 106 provides a constant DC voltage, V_{PS}. A resistor 108 is coupled in series between the voltage source 106 and the APD 102 to provide a reverse bias voltage V_{PD} to the photo-diode 102. The reverse bias voltage V_{PD} is preferably in the range of 30 to 70 volts, is more preferably in the range of 35 to 60 volts, and is approximately 50 volts, plus or minus 5 volts, in some implementations.

Because the resistor 108 and the APD 102 are in series, the current through the resistor 108 is the same as the photo-current (i_{PD}) through the APD 102. Accordingly, the voltage drop (V_{drop}) across the resistor 108 is equal to i_{PD}×R, where R denotes the resistance of the resistor 108. The photo-current i_{PD} through the APD 102 is a function of the intensity of the input optical signals. As i_{PD} increases in response to strong incoming optical signals, V_{drop} increases correspondingly, and the reverse bias voltage applied to the APD 102 (V_{PD}) decreases. In other words, V_{PD} is determined by:

V_{PD}V_{PS}−i_{PD}×R

Because the gain of the photo-current i_{PD} is a function of the reverse bias voltage V_{PD} applied to the APD 102, the gain of the photo-current i_{PD} decreases as the input optical power level increases. The decrease in current gain limits the photo-current generated. At a certain light intensity, the current gain of i_{PD} approaches unity and the APD 102 behaves like a PIN photodiode. Thus, the optical signal receiver 100 can be used in short haul optical links, where the input optical power level tends to be relatively high.

At low input optical power, the optical signal receiver 100 generates a small photo-current i_{PD}. The reverse bias voltage of the APD 102 is not significantly affected. Thus, at low input optical power, the optical signal receiver 100 behaves like a conventional APD receiver and can be used in long haul optical links, as well as in short haul optical links.

In one particular embodiment, the resistance of the resistor 108 is approximately 50K Ohms. The dynamic range of an APD receiver according to this embodiment is approximately 33 dB (e.g., between a maximum input optical power of one mwatt and a minimum input optical power of 0.5 μwatts). In comparison to some conventional optical signal receivers that have a dynamic range of approximately 20 dB (e.g., between a maximum input optical power of 50 μwatts and a minimum input optical power of 0.5 μwatts), this embodiment has a much higher dynamic range. In other embodiments of the receiver shown in FIG. 1, the resistance of the resistor 108 is between 10K Ohms and 200K Ohms.

In one aspect, the resistance of the resistor 108 is chosen according to the saturation level of the amplifier circuit 104 of the optical signal receiver. Preferably, the resistance of the resistor 108 is chosen such that, when the photo-current approaches saturation level of the amplifier circuit 104, the current gain of the photo diode 102 is near unity.

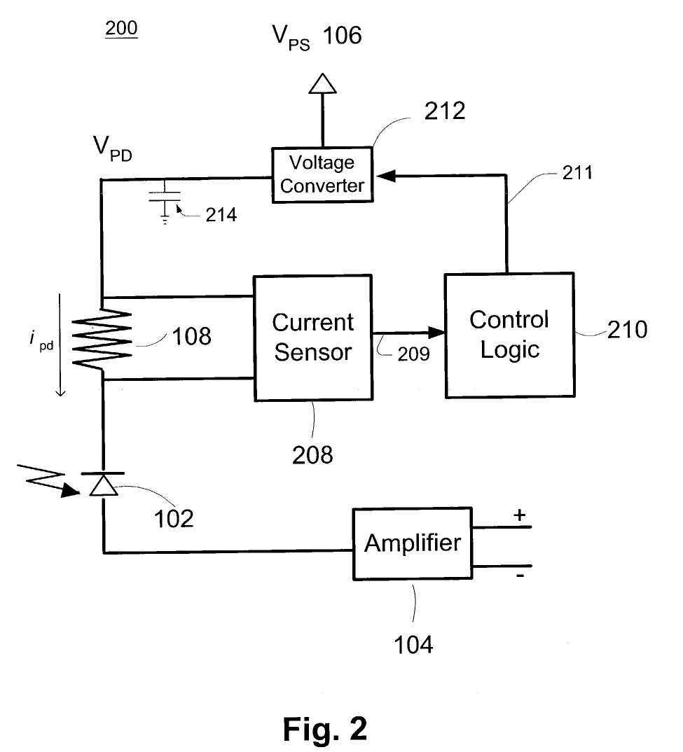

A portion of an optical signal receiver 200 according to a second embodiment of the present invention is shown in FIG. 2. In this embodiment, the reverse voltage bias of the APD 102 is regulated by a current sensor 208, control logic 210 and voltage converter 212. A power supply 106 supplies a source voltage (V_{PS}) to the voltage converter 212. The voltage converter 212 converts the source voltage V_{PS} to a reverse bias voltage (V_{PD}), which is provided to the APD 102. The voltage converter may be a switching power supply that pumps charge onto a voltage supply node (e.g., the V_{PD} voltage node) until a feedback signal indicates that a specified voltage has been achieved. The feedback signal may be produced by a voltage divider (for example, a ladder or two or more resistors) having a top node at the V_{PD} voltage and an intermediate node from which the feedback signal is obtained. A capacitor 214 to ground is used to remove or reduce fluctuations in the reverse bias voltage (V_{PD}). In this embodiment, the resistor 108, which is used as part of the current sensor 208, has a resistance of approximately 50K Ohms. In other embodiments, the resistor 108 may have a smaller resistance (e.g.,10K Ohms), with the current sensor 208 being configured to have higher sensitivity to changes in the voltage across the resistor 108.

With reference still to FIG. 2, when an optical signal is detected by the APD 102, a photo-current i_{PD} is generated. The current sensor 208 detects the increase in photo-current i_{PD} and generates a signal 209 proportional to or otherwise dependent on the photo-current. The control logic 210, in response to the current sensor's output 209, generates control signals 211 that cause the voltage converter 212 to reduce the reverse bias voltage (V_{PD}). When the reverse bias voltage V_{PD} is reduced, the current gain of the APD 102 is correspondingly limited. An even stronger optical signal will cause voltage converter 212 to further decrease the reverse bias voltage V_{PD}. The result is a further decrease in the current gain of the APD 102. When the received optical signals are sufficiently strong, the current gain of the APD approaches unity. In that event, the APD 102 behaves like a PIN photo-diode. Thus, at low input optical power, the optical signal receiver 200 behaves like a conventional APD receiver and is highly sensitive. And, at high input optical power, the optical signal receiver 200 behaves like a PIN-based receiver and overloads at a higher input optical power than APD receivers not implementing the present invention.

The control logic 210 may be implemented, for example, in a microprocessor, a micro-controller, a programmable logic array (PLA), a field programmable logic array (FPGA) an application specific integrated circuit (ASIC) or any other computational device. The control logic 210 may include various means for correlating voltage target levels with monitored current levels. For example, the control logic may employ look-up tables to correlate output voltage with monitored current levels.

The current sensor 208 may range in complexity from a series coupled resistor to a current mirror, for example. The current sensor 208 provides as an output a signal 209 proportional to the received signal strength. In an embodiment using a series resistor, this signal corresponds to the voltage drop across the resistor 108, as described above in relation to the first described embodiment.

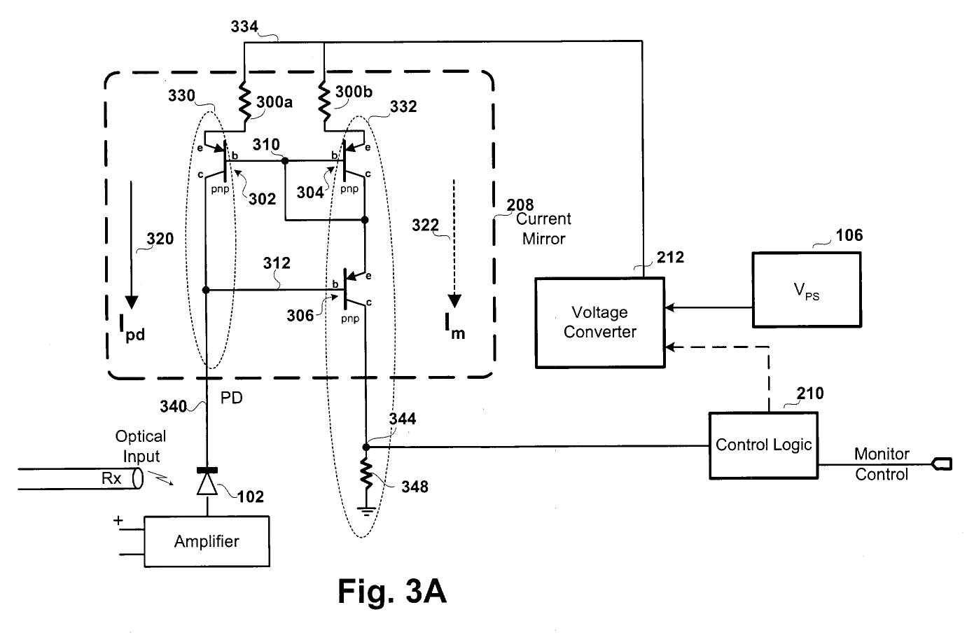

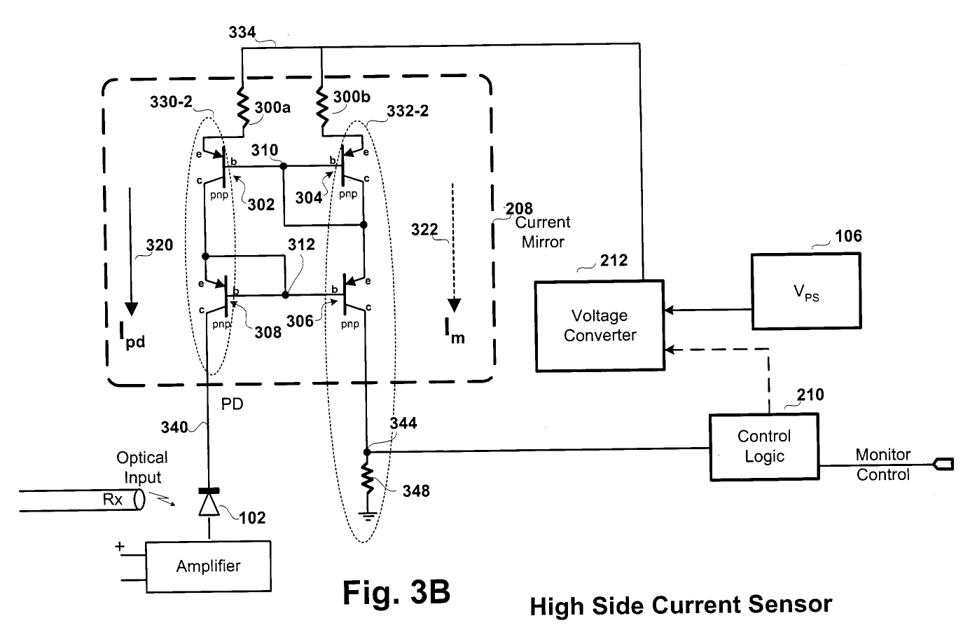

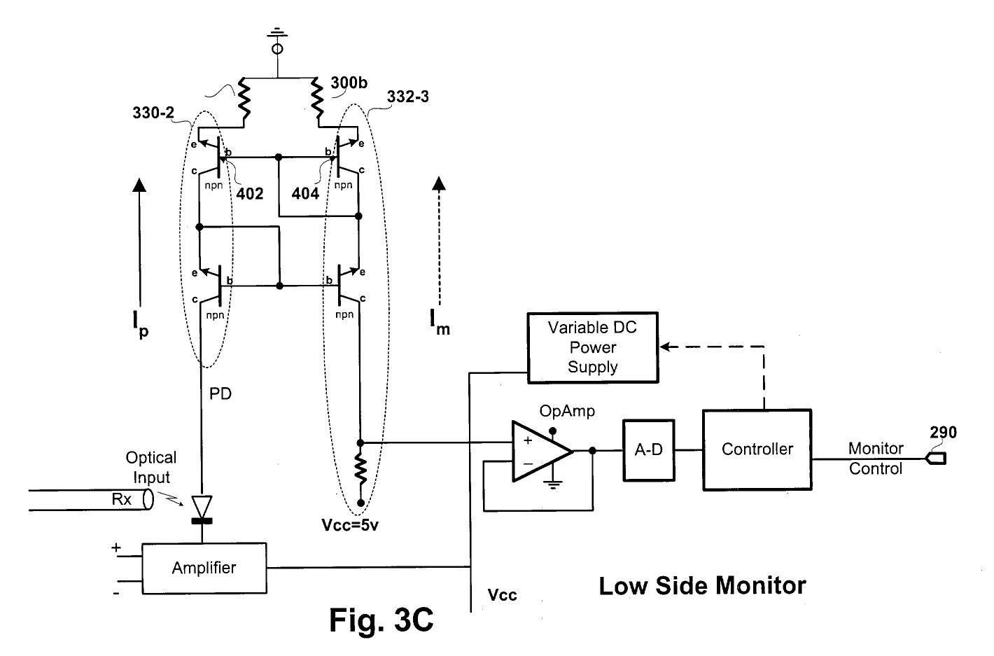

In an embodiment using a current mirror, as shown in FIG. 3A, the current sensor 208 has two legs—a photo-detector leg 330 and a mirror leg 332. The photo-detector current “I_{pd}” passes through the photo-detector “PD” leg 330, and the mirror current “Iₘ” passes through the mirror leg 332. The mirror current provides a signal proportional to (or approximately proportional to) the received signal strength. Both legs of the current mirror couple on the positive side to a voltage source node 334. Voltage converter 212 controls the voltage on node 334 in accordance with a control signal from the control logic 210. The photo-detector leg of the current mirror couples via line 340 with the high voltage terminal of the APD 102 (i.e., line 340 is coupled to n-doped portion of the APD 102). In the example shown, the supply voltage is controllable between 30 and 60 volts and the photo-detector 102 is an APD. In alternate embodiments of the invention a PIN type photo-detector may be utilized with a corresponding reduction in the supply voltage level to 3-5 volts for example. The mirror leg 332 of the current mirror supplies the mirror current Iₘ. The level of Iₘ corresponds to the received optical signal level as detected by the photo-detector 102.

FIGS. 3A-B show alternate examples of current mirrors used in a third embodiment of the present invention, which is similar in many respects to the second embodiment. The current mirror includes a pair of back-to-back bipolar type transistors 302 and 304 configured as a current mirror. The sense transistor 302 defines the photo-detector (PD) leg 330 of the current mirror in which flows the photo-detector current I_{pd} 320. The mirror transistor 304 is in the mirror leg 332 in which flows the mirror current Iₘ 322. The bases of the sense and mirror transistors are coupled to one another and to the collector of the mirror transistor. In the high side embodiment shown in FIGS. 3A-B the sense and mirror transistors comprise ‘pnp’ type bipolar transistors.

In FIG. 3A, the sense and mirror transistors, 302 and 304, are supplemented by an isolation transistor 306, to form a Wilson mirror, which is a well known mirror circuit described in many text books. The isolation transistor 306 has an emitter coupled to the collector of mirror transistor 304, a base coupled at node 312 to the collector of the sense transistor 302, and an emitter coupled to monitor node 344. The isolation transistor 306 helps to make the collector-to-emitter voltage drop across the mirror transistor 304 relatively constant at about 0.7 volts, even in the event of large changes in the mirror current. The collector-to-emitter voltage across the sense transistor 302 can vary considerably, depending on the amount of current drawn by the APD 102. In other embodiments, the isolation transistor 306 could be replaced by a Schmidt or Zener diode.

The current Iₘ flowing through the monitor leg 332 develops a voltage across resistor 348, thereby generating a monitor signal on monitor node 344. The resistance of resistor 348 is selected so as to provide a monitor signal with an appropriate voltage range, and is set to 10k ohm in one embodiment. Other appropriate resistance values would be used in other embodiments. Monitor node 344 provides a monitor signal that is proportional, or at least approximately proportional, to the photo-detector current and that is coupled to the control logic 210.

In the alternate embodiment shown in FIG. 3B, another non-linear isolation element is added to the photo-detector leg 330-2 between the sense transistor 302 and the photo-detector 102. Suitable non-linear isolation elements include: a Schmidt or Zener diode, or a bipolar transistor. In the embodiment shown in FIG. 3B the non-linear isolation element is a bipolar transistor 308 with an emitter terminal coupled to the collector of the sense transistor 302 and a collector coupled to the photo-detector 102. The base of transistor 308 is coupled to the collector of the sense transistor 302 as well as to the base of the other isolation transistor 306. This embodiment has more linear operation than the embodiment shown in FIG. 3A because the collector-to-emitter voltages in both the sense and mirror transistors 302, 304 are relatively constant at about 0.7 volts, even when the currents in the photo-detector and mirror legs varies over a large range.

In the embodiments shown in FIGS. 3A-B the emitters of the sense and mirror transistors 302, 304 couple to the voltage source 212 via node 334 and resistors 300a, 300b, respectively. These resistors 300a, 300b may be sized appropriately for embodiments of the invention in which the photo-detector 102 is an avalanche photodiode, or a PIN diode. Resistors 300a, 300b may have different resistance values. For instance, if the current sensor 208 is configured to provide a mirror current Iₘ that is one tenth the magnitude of the photo-detector current I_{pd}, resistor 300b will have one tenth of the resistance (e.g., 100 ohms) of resistor 300a (e.g., 1000 ohms), and transistor 304 will be sized to pass one tenth as much current as transistor 302 when having identical terminal voltages. This configuration provides different but proportional currents to pass through the mirror and photo-detector legs. Having a unsymmetric current sensor 208 reduces the amount of power used to perform the current monitoring function.

Referring to FIG. 3C, a current mirror in another embodiment may also be coupled on the “low side” of the receiver to monitor received signal strength from the photo-detector. In such a configuration, the mirror transistors 402, 404 are ‘npn’ bipolar types with the emitters of the sense and mirror transistors 402, 404 coupled to a voltage sink and with the monitor node coupled through a resistor to a voltage source.

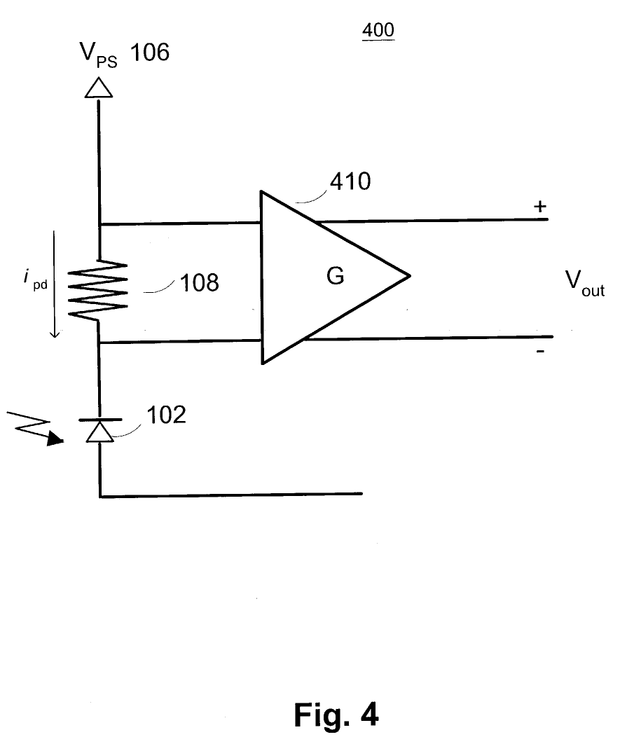

FIG. 4 is a block diagram depicting a portion of an optical signal receiver 400 in accordance with yet another embodiment of the invention. The optical signal receiver 400 includes voltage source 106, APD 102 and resistor 108 coupled in series between the voltage source 106 and the APD 102. In addition, the optical signal receiver 400 includes a transimpedance amplifier 410 coupled across the resistor 108. The transimpedance amplifier 410, in this embodiment, becomes saturated when the input photo-current exceeds a certain threshold level, at which the output voltage will cease to vary correspondingly with the photo-current i_{PD}.

In operation, in response to a weak optical signal (e.g., approximately 0.5 μwatt), a small photo-current i_{PD} is generated. The small photo-current i_{PD} causes a correspondingly small voltage drop across the resistor 108. As a result, the gain of the photo-current is not greatly affected. The transimpedance amplifier 410 detects the small photo-current i_{PD}, and generates an amplified voltage signal Vₒᵤₜ as output. Thus, in response to a weak optical signal, the optical signal receiver 400 behaves like a conventional APD receiver.

In response to a strong optical signal (e.g., approximately one milliwatt), the photo-diode will generate a very large photo-current i_{PD} if the reverse bias voltage V_{PD} remains the same. However, in the present embodiment, an increase in i_{PD} causes a corresponding increase in voltage drop across the resistor 108 and a corresponding decrease in photo-current gain. For instance, if the received optical signal has a power of approximately one mwatt, the current gain is approximately at unity. The optical signal receiver 400, therefore, behaves like a PIN-based optical signal receiver.

The foregoing descriptions of specific embodiments of the present invention are presented for purposes of illustration and description. The embodiments were chosen and described in order to best explain the principles of the invention and its practical applications, to thereby enable others skilled in the art to best utilize the invention. They are not intended to be exhaustive or to limit the invention to the precise forms disclosed. Many modifications and variations suitable to the particular use contemplated are possible in view of the above teachings. For instance, it should be obvious to those skilled in the art having the benefit of this disclosure that the present invention can be applied to receiver parts of an optoelectronic transceiver.

What is claimed is:

1. An optical signal receiver, comprising:
a circuit operable to provide a voltage; and
a photo-diode coupled to the circuit to receive the voltage, the photo-diode operable to generate a photo-current in response to a received optical signal, wherein the circuit is configured to adjust a current gain of the photo-current according to a power of the received optical signal by adjusting the voltage.

2. The optical signal receiver of claim 1, wherein the photo-diode comprises an avalanche photo-diode.

3. The optical signal receiver of claim 1, wherein the circuit further comprises:
a voltage source; and
a resistor having a resistance in a range between about 10K-Ohms and about 200 K-Ohms coupled between the voltage source and the photo-diode to provide the voltage.

4. The optical receiver of claim 3, wherein the resistor has a resistance of approximately 50 K-Ohms.

5. The optical signal receiver of claim 4, wherein the optical signal receiver is capable of detecting optical signals that range from approximately 1 mwatt of power to approximately 0.5 μwatts of power.

6. The optical signal receiver of claim 4, wherein the current gain is approximately at unity when the photo-current approaches a saturation level of a pre-amplifier circuit that is coupled to the photo-diode.

7. The optical signal receiver of claim 4, wherein the optical signal receiver has an input dynamic range of approximately 33 dB.

8. The optical signal receiver of claim 2, wherein the circuit comprises:
a current sensor operable to detect the photo-current;
a controller coupled to the current sensor, the controller operable to generate control signals in response to the photo-current; and
a voltage converter coupled to the controller, the voltage converter operable to provide the voltage according to the control signals.

9. The optical receiver of claim 8, wherein the current sensor includes a current mirror.

10. An optical signal receiver, comprising:
a resistor; and
a photo-diode coupled to the resistor to receive a reverse bias voltage, the photo-diode operable to generate a photo-current in response to a received optical signal, wherein the resistor lowers a gain of the photo-diode according to a power of the received optical signal by lowering the reverse bias voltage.

11. The optical signal receiver of claim 10, wherein the photo-diode comprises an avalanche photo-diode.

12. The optical signal receiver of claim 10, wherein the resistor has a resistance in a range between about 10 K-Ohms and about 200 K-Ohms.

13. The optical signal receiver of claim 10, wherein the resistor has a resistance of approximately 50K-Ohms.

14. The optical signal receiver of claim 13, wherein the optical signal receiver is capable of detecting optical signals that range from approximately 1 mwatt of power to approximately 0.5 μwatts of power.

15. The optical signal receiver of claim 13, wherein the optical signal receiver has an input dynamic range of approximately 33 dB.

16. The optical signal receiver of claim 10, further comprising a pre-amplifier coupled to the photo-diode to receive the photo-current.

17. The optical signal receiver of claim 16, wherein the gain of the photo-diode is approximately at unity when the photo-current approximates a saturation level of the pre-amplifier.

18. An optical signal receiver, comprising:
an adjustable voltage source operable to provide a voltage;
a photo-diode coupled to receive the voltage and operable to generate a photo-current in response to a received optical signal;
a current sensor operable to detect the photo-current; and
a controller coupled to the current sensor, the controller operable to generate control signals in response to the photo-current, wherein the adjustable voltage source adjusts a gain of the photo-diode according to a power of the received optical signal by adjusting the voltage.

19. The optical signal receiver of claim 18, wherein the photo-diode comprises an avalanche photo-diode.

20. The optical signal receiver of claim 18, further comprising a pre-amplifier coupled to the photo-diode to receive the photo-current.

21. The optical signal receiver of claim 20, wherein the gain of the photo-current is approximately at unity when the photo-current approximates a saturation level of the pre-amplifier.

22. The optical signal receiver of claim 18, wherein the current sensor includes a current mirror.

23. An optical signal detector, comprising:
an avalanche photo-diode having a terminal; and
a resistor coupled to the terminal to provide a reverse bias voltage to the avalanche photo-diode, wherein the resistor has a resistance in a range between about 10 K-Ohms and about 200 K-Ohms.

24. The optical signal detector of claim 23, wherein the resistor has a resistance of approximately 50K-Ohms.

25. The optical signal detector of claim 23, further comprising a transimpedance amplifier coupled across the resistor to generate an output voltage that is proportional to the photo-current.

26. An optical signal receiver, comprising:
an avalanche photo-diode operable to generate a photo-current in response to a received optical signal;
a pre-amplifier circuit coupled to the avalanche photo-diode operable to amplify the photo-current; and
a circuit coupled to the avalanche photo-diode and operable to reduce a current gain of the avalanche photo-diode so as to cause the avalanche photo-diode to behave similarly to a p-intrinsic-n photo-diode when the photo-current approaches a saturation level of the pre-amplifier circuit.

27. The optical signal receiver of claim 26, further comprising an amplifier circuit coupled to the avalanche photo-diode to receive the photo-current.

28. The optical signal receiver of claim 26, wherein the circuit comprises a resistor.

29. The optical signal receiver of claim 28, wherein the resistor has a resistance in a range between about 10 K-Ohms and about 200 K-Ohms.

30. The optical signal receiver of claim 28, wherein the resistor has a resistance of approximately 50K-Ohms.

31. An optical signal receiver, comprising:
means for generating a photo-current in response to a received optical signal; and
means for adjusting a gain of the photo-current according to a power of the received optical signal.

32. The optical signal receiver of claim 31, further comprising means for sensing the photo-current.

33. The optical signal receiver of claim 32, wherein the means for adjusting further comprises means for adjusting a reverse bias voltage for the means for generating.

34. The optical signal receiver of claim 32 further comprising means for amplifying the photo-current to produce an output.
